(19) United States
(12) Patent Application Publication
(10) Pub. No.: US 2016/0187597 A1
(43) Pub. Date: Jun. 30, 2016

(54) PHOTOELECTRIC CONVERTER, OPTICAL COMMUNICATION SYSTEM AND ITS TEST METHOD

(71) Applicant: HON HAI PRECISION INDUSTRY CO., LTD., New Taipei (TW)

(72) Inventor: CHEN-HAN LIN, Tu-Cheng (TW)

(21) Appl. No.: 14/690,088

(22) Filed: Apr. 17, 2015

(30) Foreign Application Priority Data
Dec. 29, 2014 (TW) 103146149

(51) Int. Cl. G02B 6/42; G02B 1/04; H04B 10/079; G02B 6/32

(52) U.S. Cl. CPC G02B 6/4214; G02B 6/32; G02B 6/4226; G02B 1/041; G02B 6/4227; H04B 10/0799

(57) ABSTRACT

A photoelectric converter adapted for rectifying and converting an optical signal generated by a laser source, includes a frame and an optical coupling module mounted on the frame. The optical coupling module includes a first lens, an adjustable support including a mirror, and a second lens. The first and second lenses and the mirror define an optical path. The adjustable support includes an outer support connected to the frame and an inner support connected to the outer support by a plurality of adjustable tension springs. The mirror is rotatably mounted on the inner support by a plurality of rotating supports. Adjustment of the adjustable tension springs laterally moves the inner support to thereby adjust the lateral position of the mirror. Rotation of the rotating supports rotates the mirror.

### FIELD

The subject matter herein generally relates to optical fiber communication, and especially to a photoelectric converter capable of rectifying an optical signal, an optical communication system using the photoelectric converter and a test method of the optical communication system.

### BACKGROUND

In the field of optical fiber communication, an electrical signal is converted into an optical signal by a laser source, the optical signal is then coupled to an interior of an optical fiber for transmission by a photoelectric converter. However, in the photoelectric converter of the prior art, due to fabrication errors of optical surfaces of the photoelectric converter, the optical signal transmitted to the optical fiber can attenuate significantly.

### BRIEF DESCRIPTION OF THE DRAWINGS

Implementations of the present technology will now be described, by way of example only, with reference to the attached figures.

FIG. 1 is a diagrammatic view of an optical communication system in accordance with an embodiment of the present disclosure.

FIG. 2 is a cross sectional view of an adjustable support of the optical communication system, taken across line II-II of FIG. 1.

FIG. 3 is a flowchart showing major blocks of a test method of the optical communication system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

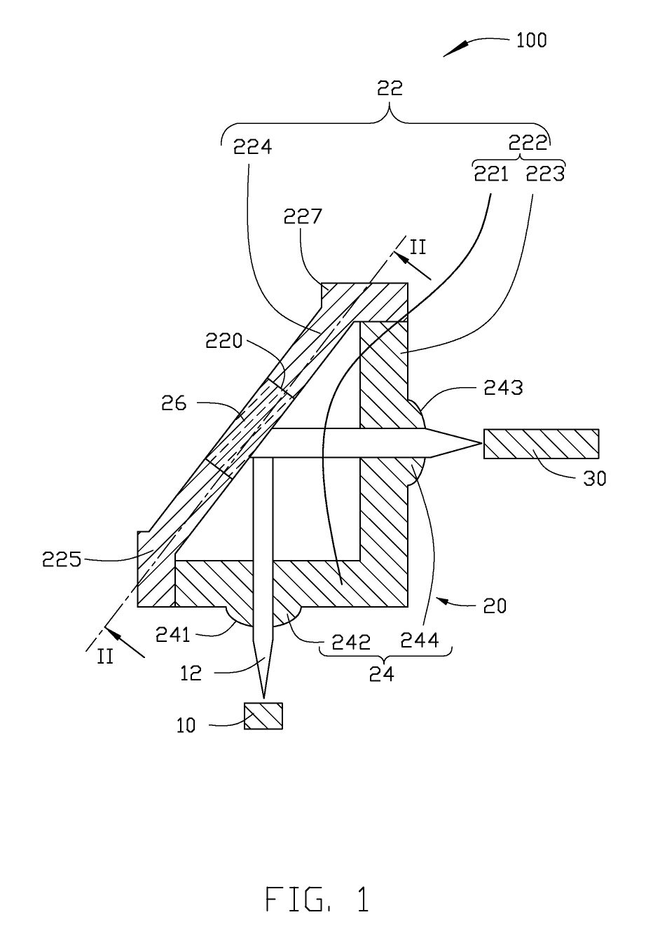

Referring to FIG. 1, an optical communication system 100 in accordance with an embodiment of the present disclosure is shown. The optical communication system 100 includes a laser source 10 for generating an optical signal 12, a photoelectric converter 20 for rectifying and converting the optical signal 12 generated by the laser source 10, and an optical fiber 30 for receiving the optical signal 12.

The photoelectric converter 20 includes a frame 22, and an optical coupling module 24.

The frame 22 is made of a transparent material. For example, the material of the frame 22 may include silica gel or polyetherimide (PEI). The frame 22 is substantially triangular, and includes a first supporting frame 222 and a second supporting frame 224 connected with two ends of the first supporting frame 222.

The first supporting frame 222 is substantially L-shaped. The first supporting frame 222 includes a horizontal first supporting portion 221 and a second supporting portion 223 vertical to the first supporting portion 221. An angle between the first supporting portion 221 and the second supporting frame 224 is 45 degrees.

The second supporting frame 224 defines a rectangular embedding hole 220. Two connecting ends 225, 227 extend from two ends of the second supporting frame 224, respectively. The connecting end 225 of the second supporting frame 224 is coupled to the first supporting portion 221 of the first supporting frame 222. The connecting end 227 of the second supporting frame 224 is coupled to the second supporting portion 223 of the first supporting frame 222.

The optical coupling module 24 includes a first lens 242 formed on the first supporting portion 221 of the first supporting frame 222, a second lens 244 formed on the second supporting portion 223 of the first supporting frame 222, and an adjustable support 26 received and fixed in the rectangular embedding hole 220 of the second supporting frame 224. The laser source 10 is arranged near the first lens 242. The optical fiber 30 is arranged near the second lens 244.

The first lens 242 is configured to convert the optical signal 12 generated by the laser source 10 into collimated light (parallel light). The adjustable support 26 is configured to reflect the collimated light to the second lens 244. The second lens 244 is configured to focus and couple the collimated light reflected by the adjustable support 26 to the optical fiber 30 for transmission. The first and second lenses 242, 244 are made of a transparent material. For example, the material of the first and second lenses 242, 244 may include silica gel or polyetherimide (PEI). In this embodiment, the first lens 242, the second lens 244, and the first supporting frame 222 are integrally formed. In particular, the first lens 242 extends outwards from an outer face of the first supporting portion 221 of the first supporting frame 222, and the second lens 244 extends outwards from an outer face of the second supporting portion 223 of the first supporting frame 222. The first lens 242 has an aspheric light inputting surface 241, and the laser source 10 is arranged opposite to the light inputting surface 241 of the first lens 242. The second lens 244 has an aspheric light outputting surface 243, and the optical fiber 30 is arranged opposite to the light outputting surface 243 of the second lens 244.

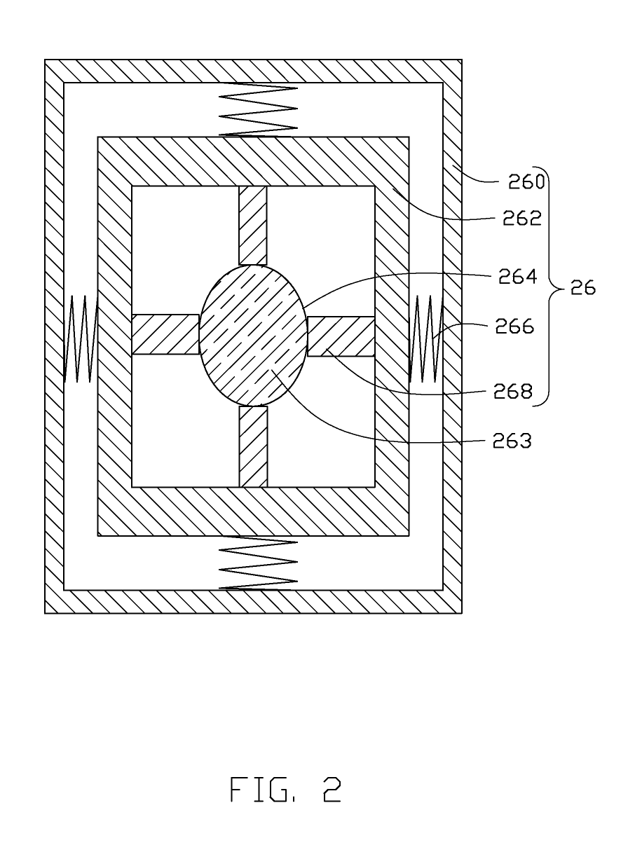

Also referring to FIG. 2, the adjustable support 26 includes a rectangular outer support 260, a rectangular inner support 262, a mirror 264, four adjustable tension springs 266, and two rotating supports 268. The inner support 262, the mirror 264, the four adjustable tension springs 266, and the two rotating supports 268 are received in the outer support 260. The first and second lenses 242, 244 and the mirror 264 define an optical path.

Each of four edges of the inner support 262 is parallel to a corresponding one of four edges of the outer support 260.

The four adjustable tension springs 266 are sandwiched between the inner support 262 and the outer support 260. In particular, two ends of each tension spring 266 are sandwiched between two parallel edges of the inner support 262 and the outer support 260. Adjustment of the adjustable tension springs 266 laterally moves the inner support 262 to thereby adjust the lateral position of the mirror 264. Displacements of the inner support 262 and the mirror 264 relative to the outer support 260 are regulated by controlling expansion or contraction of the adjustable tension springs 266.

The two rotating supports 268 and the mirror 264 are received in the inner support 262. The two rotating supports 268 are perpendicular to each other. Two ends of each rotating support 268 are fixed on two opposite edges of the inner support 262, respectively.

The mirror 264 is rotatably mounted on the inner support 262 by the rotating supports 268. The mirror 264 is capable of rotating relative to the rotating supports 268 so as to adjust a rotation angle of the mirror 264 relative to the inner support 262 and thus control an incident angle and a reflected angle of the collimated light radiated on the mirror 264. The mirror 264 is provided with a light reflecting face 263 at one side thereof.

The assembly positions of the laser source 10 and the optical fiber 30 relative to the photoelectric converter 20, the positions of the first lens 242 and the second lens 244 formed on the first supporting frame 222, and the position and the angle of the mirror 264 formed on the second supporting frame 224 must be very accurate, otherwise very weak optical signal 12 or even no optical signal 12 will be received from the optical fiber 30. Therefore, before transmit the optical signal 12 using the optical communication system 100, the optical communication system 100 needs to be tested.

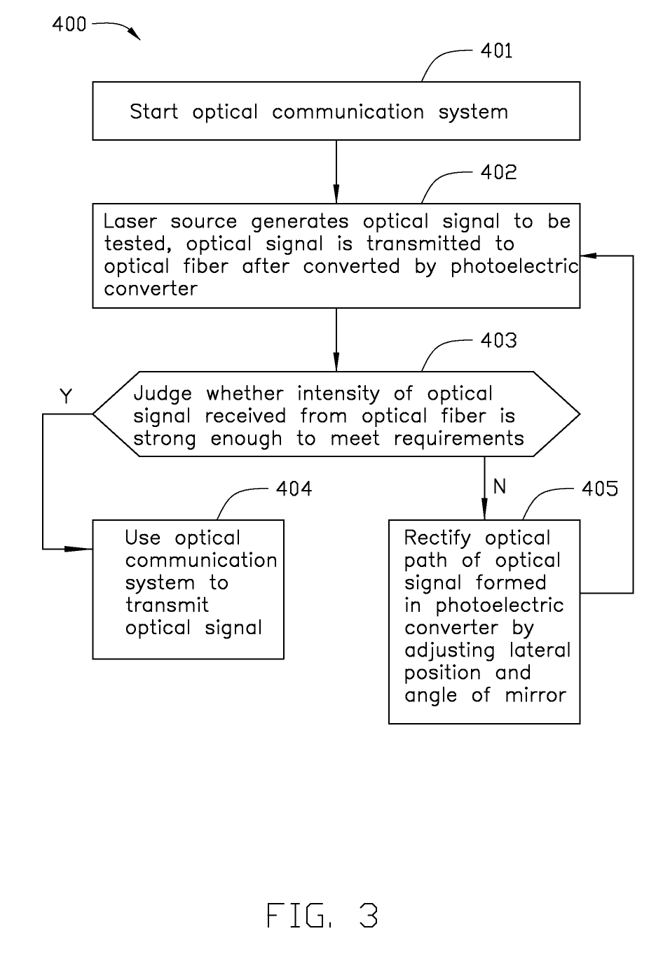

Referring to FIG. 3, a flowchart showing a test method 400 of the optical communication system of FIG. 1 is presented. The method 400 is provided by way of example, as there are a variety of ways to carry out the method 400. The method 400 described below can be carried out using the configurations illustrated in FIGS. 1-2, for example, and various elements of these figures are referenced in explaining the method 400. Each block shown in FIG. 3 represents one or more processes, methods, or subroutines, carried out in the method 400. Furthermore, the illustrated order of blocks is illustrative only and the order of the blocks can be changed. Additional blocks can be added or fewer blocks may be utilized without departing from this disclosure. The method 400 can begin at block 401.

At block 401, the method 400 comprises starting the optical communication system 100.

At block 402, the laser source 10 generates the optical signal 12 to be tested, the optical signal 12 is transmitted to the optical fiber 30 after converted by the photoelectric converter 20. The optical signal 12 through the first lens 242 and the first supporting portion 221 of the first supporting frame 222 is converted into the collimated light and then projected on the light reflecting face 263 of the mirror 264. The collimated light is reflected to the second supporting portion 223 of the first supporting frame 222 by the light reflecting face 263 of the mirror 264, and then penetrates the second supporting portion 223 of the first supporting frame 222 and the second lens 244. The second lens 244 then focuses and couples the collimated light to the optical fiber 30 for transmission.

At block 403, the method 400 judges whether the intensity of the optical signal 12 received from the optical fiber 30 is strong enough to meet requirements. If the intensity of the optical signal 12 received from the optical fiber 30 is strong enough to meet the requirements, block 404 is implemented. Otherwise, if the intensity of the optical signal 12 received from the optical fiber 30 is weak enough to exceed allowed error or no optical signal 12 is received from the optical fiber 30, that means errors resulted from assembly deviations of the constituent elements of the photoelectric converter 20 exist, and then block 405 is implemented.

At block 404, the method 400 further comprises using the optical communication system 100 to transmit the optical signal 12.

At block 405, the optical path of the optical signal 12 formed in the photoelectric converter 20 is rectified by adjusting the lateral position and the angle of the mirror 264. In particular, the lateral position of the mirror 264 relative to the outer support 260 is regulated by controlling the expansion or the contraction of the adjustable tension springs 266, the angle of the mirror 264 relative to the inner support 262 is adjusted by rotating the mirror 264 relative to the rotating supports 268. After the lateral position and the angle of the mirror 264 are adjusted, if the intensity of the optical signal 12 received from the optical fiber 30 is strong enough to meet the requirements, a user can use the optical communication system 100 to transmit the optical signal 12. Otherwise, if the intensity of the optical signal 12 received from the optical fiber 30 is weak enough to exceed allowed error or no optical signal 12 is received from the optical fiber 30, the optical path of the optical signal 12 formed in the photoelectric converter 20 is rectified again by adjusting the lateral position and the angle of the mirror 264 until the optical signal 12 with strong intensity is received from the optical fiber 30.

According to the present disclosure, since the optical path of the optical signal 12 formed in the photoelectric converter 20 can be rectified by adjusting the lateral position and the angle of the mirror 264, tolerance errors of the optical communication system 100 increase.

The embodiments shown and described above are only examples. Many details are often found in the art such as the other features of an optical communication system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A photoelectric converter adapted for rectifying and converting an optical signal generated by a laser source, comprising:
a frame;
an optical coupling module mounted on the frame, comprising a first lens, an adjustable support including a mirror, and a second lens, the first and second lenses and the mirror defining an optical path;
the adjustable support including an outer support connected to the frame and an inner support connected to the outer support by a plurality of adjustable tension springs; and
the mirror being rotatably mounted on the inner support by a plurality of rotating supports;
wherein adjustment of the adjustable tension springs laterally moves the inner support to thereby adjust the lateral position of the mirror; and
wherein rotation of the rotating supports rotates the mirror.

2. The photoelectric converter of claim 1, wherein the first lens is configured to convert the optical signal generated by the laser source into collimated light, the mirror being configured to reflect the collimated light to the second lens, the second lens being configured to focus and couple the collimated light reflected by the mirror to an optical fiber for transmission.

3. The photoelectric converter of claim 1, wherein the mirror is received in the inner support, the inner support and the adjustable tension springs being received in the outer support, the adjustable tension springs being sandwiched between the inner support and the outer support, displacements of the inner support and the mirror relative to the outer support being regulated by controlling expansion or contraction of the adjustable tension springs.

4. The photoelectric converter of claim 1, wherein the first and second lenses are made of a transparent material.

5. The photoelectric converter of claim 4, wherein the material of the first and second lenses comprises silica gel or polyetherimide.

6. The photoelectric converter of claim 1, wherein the frame is made of a transparent material, and the material of the frame comprises silica gel or polyetherimide.

7. The photoelectric converter of claim 1, wherein the frame is substantially triangular, and comprises an L-shaped first supporting frame and a second supporting frame connected with two ends of the first supporting frame, the optical coupling module being arranged on the first supporting frame, the adjustable support being arranged on the second supporting frame.

8. The photoelectric converter of claim 7, wherein the first supporting frame comprises a horizontal first supporting portion and a second supporting portion vertical to the first supporting portion, one connecting end of the second supporting frame being coupled to the first supporting portion of the first supporting frame, another connecting end of the second supporting frame being coupled to the second supporting portion of the first supporting frame, the first lens being formed on the first supporting portion of the first supporting frame, the second lens being formed on the second supporting portion of the first supporting frame.

9. The photoelectric converter of claim 8, wherein the second supporting frame defines an embedding hole for receiving and fixing the adjustable support therein.

10. The photoelectric converter of claim 8, wherein the first lens extends outwards from an outer face of the first supporting portion of the first supporting frame, and the second lens extends outwards from an outer face of the second supporting portion of the first supporting frame.

11. An optical communication system comprising:
a laser source configured to generate an optical signal;
an optical fiber configured to receive the optical signal; and
a photoelectric converter configured to rectify and convert the optical signal, comprising:
a frame;
an optical coupling module mounted on the frame, comprising a first lens, an adjustable support including a mirror, and a second lens, the first and second lenses and the mirror defining an optical path;
the adjustable support including an outer support connected to the frame and an inner support connected to the outer support by a plurality of adjustable tension springs; and
the mirror being rotatably mounted on the inner support by a plurality of rotating supports;
wherein adjustment of the adjustable tension springs laterally moves the inner support to thereby adjust the lateral position of the mirror; and
wherein rotation of the rotating supports rotates the mirror.

12. The optical communication system of claim 11, wherein the first lens is configured to convert the optical signal generated by the laser source into collimated light, the mirror being configured to reflect the collimated light to the second lens, the second lens being configured to focus and couple the collimated light reflected by the mirror to an optical fiber for transmission.

13. The optical communication system of claim 11, wherein the mirror is received in the inner support, the inner support and the adjustable tension springs being received in the outer support, the adjustable tension springs being sandwiched between the inner support and the outer support.

14. The optical communication system of claim 11, wherein the first and second lenses are made of a transparent material, and the material of the first and second lenses comprises silica gel or polyetherimide.

15. The optical communication system of claim 11, wherein the frame is made of a transparent material, and the material of the frame comprises silica gel or polyetherimide.

16. The optical communication system of claim 11, wherein the frame is substantially triangular, and comprises an L-shaped first supporting frame and a second supporting frame connected with two ends of the first supporting frame, the optical coupling module being arranged on the first supporting frame, the adjustable support being arranged on the second supporting frame.

17. The optical communication system of claim 16, wherein the first supporting frame comprises a horizontal first supporting portion and a second supporting portion vertical to the first supporting portion, one connecting end of the second supporting frame being coupled to the first supporting portion of the first supporting frame, another connecting end of the second supporting frame being coupled to the second supporting portion of the first supporting frame, the first lens being formed on the first supporting portion of the first supporting frame, the second lens being formed on the second supporting portion of the first supporting frame.

18. The optical communication system of claim 17, wherein the second supporting frame defines an embedding hole for receiving and fixing the adjustable support therein.

19. The optical communication system of claim 17, wherein the first lens extends outwards from an outer face of the first supporting portion of the first supporting frame, and the second lens extends outwards from an outer face of the second supporting portion of the first supporting frame.

20. A test method of the optical communication system as claimed in claim 11, the method comprising:
starting the optical communication system;
the laser source generating the optical signal to be tested, the optical signal being transmitted to the optical fiber after converted by the photoelectric converter;
judging whether the intensity of the optical signal received from the optical fiber is strong enough to meet the requirements;
if the intensity of the optical signal received from the optical fiber is strong enough, using the optical communication system to transmit the optical signal;
otherwise, if the intensity of the optical signal received from the optical fiber is weak enough to exceed allowed error or no optical signal is received from the optical fiber, rectifying the optical path of the optical signal transmitted in the photoelectric converter by adjusting the position and the angle of the mirror until the optical signal with strong enough intensity is received from the optical fiber.
